(19) United States
(12) Patent Application Publication
(10) Pub. No.: US 2026/0233982 A1
(43) Pub. Date: Aug. 13, 2026

(54) Multi-Purpose Elevating Work Platform with Dual Driving Wheels

(71) Applicants: NOBLELIFT INTELLIGENT EQUIPMENT CO., LTD., Changxing County Huzhou (CN); Changxing Yongxuan Mechanical Co., Ltd, Changxing County Huzhou (CN)

(72) Inventors: Roman BUZUNOV, Changxing County Huzhou (CN); Guoming DING, Changxing County Huzhou (CN); Zelong HE, Changxing County Huzhou (CN); Zhiyu ZHANG, Changxing County Huzhou (CN); Ying MAO, Changxing County Huzhou (CN); Linqiang SHI, Changxing County Huzhou (CN); Xuemin LIN, Changxing County Huzhou (CN); Feifei WANG, Changxing County Huzhou (CN)

(21) Appl. No.: 19/438,512

(22) Filed: Dec. 31, 2025

Related U.S. Application Data
(63) Continuation of application No. PCT/CN2025/120764, filed on Sep. 11, 2025.

(30) Foreign Application Priority Data
Feb. 8, 2025 (CN) 202510141550.3
Feb. 8, 2025 (CN) 202520199587.7
Feb. 17, 2025 (CN) 202520248865.3

(51) Int. Cl. B66F 11/04

(52) U.S. Cl. CPC B66F 11/04

(57) ABSTRACT

Some embodiments of the present invention provide a multi-purpose elevating work platform with dual driving wheels, which aims to solve the defect that a conventional multi-purpose elevating work platform has poor motion flexibility and thus is difficult to meet convenient movement between a plurality of scenarios in a warehouse. The multi-purpose elevating work platform in the present invention includes a vehicle body, a first driving wheel, and a second driving wheel, the first driving wheel and the second driving wheel can be independently driven to generate a normal mode, a multi-directional movement mode and a small steering radius mode, so as to realize conventional movement, inclining, horizontal parallelism and small-radius steering, which covers most scenarios of moving in a narrow goods aisle, so that the multi-purpose elevating work platform can move more flexibly to relieve the burden of an operator.

### TECHNICAL FIELD

The present invention relates to a field of motion control of storage and transportation vehicles, and relates to a multi-purpose elevating work platform with dual driving wheels.

### BACKGROUND

An order picker or MPEP (multi-purpose elevating work platform) is storage and transportation vehicle for industrial use, is equipment used in warehouses and logistics centers, and is mainly used for sorting, carrying, picking and stacking goods on shelves as well as performing of other work on height. An operator drives the order picker around working areas, and the operator is lifted by raising a platform carrying the operator, so that goods can be taken or placed on the higher level shelves or other tasks required person to be lifted from ground level can be performed.

When taking or placing the goods between the shelves, the operator hopes that the MPEP can have a motion mode other than a conventional vehicle, so as to meet the function of convenient movement between the shelves and achieve higher motion flexibility for improvement of productivity. For example, there is a scenario in which the operator needs to take and/or place goods between two parallel shelves, and an aisle between the shelves is often wider than a vehicle body, such that the operator needs to adjust the position of the vehicle body laterally; or, at an angle like a dead end, the operator need to turn round the equipment, but the width of the aisle is not sufficient enough to complete the turn-round movement within a small number of operations.

In the above scenario, the operator often needs to perform a large number of operations to move the machine in place, which aggravates the burden of the operator, reduces the efficiency, and increases the operational costs.

A large number of above scenarios repeatedly occur during use of existing solutions in order picking and task support scenarios, so that there is an urgent need to provide more operation modes for the order picker and task support vehicle to solve the inconvenience caused by the above scenarios.

### SUMMARY

The present invention overcomes the defect that a conventional middle and high-level order picker (task support vehicle) has related to poor motion flexibility and thus is difficult to meet convenient movement between a plurality of scenarios in a working facility, and some embodiments of the present invention provide a multi-purpose elevating work platform with dual driving wheels. The multi-purpose elevating work platform can implement a plurality of motion modes, which cover most scenarios of moving in a narrow aisles and restricted environment, so that the equipment can move more flexibly to reduce the workload of an operator.

In order to solve the above technical problem, the present invention uses the following technical solutions:

A multi-purpose elevating work platform with dual driving wheels, the multi-purpose elevating work platform includes a vehicle body, a first driving wheel, a second driving wheel, a plurality of universal wheels and a motion control module; the universal wheels are disposed at positions close to an outer edge of the vehicle body, the first driving wheel and the second driving wheel are located in the length direction of the vehicle body; the multi-purpose elevating work platform further includes a first driving structure and a second driving structure, one end of the vehicle body is provided with the first driving structure, the other end of the vehicle body is provided with the second driving structure, the first driving structure drives the first driving wheel to rotate or steer, the second driving structure drives the second driving wheel to rotate or steer; the multi-purpose elevating work platform has a plurality of motion modes, and according to the plurality of motion modes, the motion control module is configured to control at least one of the first driving wheel and the second driving wheel to rotate and control at least one of the first driving wheel and the second driving wheel to steer.

In some embodiments, the plurality of motion modes include a normal mode, a multi-directional movement mode and a small steering radius mode; in the normal mode, the motion control module is configured to control one or two of the first driving wheel and the second driving wheel to steer and control one or two of the first driving wheel and the second driving wheel to rotate; in the multi-directional movement mode, the motion control module is configured to control the first driving wheel and the second driving wheel to steer synchronously in a same steering direction and by a same angle, and the motion control module is configured to control one or two of the first driving wheel and the second driving wheel to rotate; and in the small steering radius mode, the motion control module is configured to control the first driving wheel and the second driving wheel to steer synchronously in opposite steering directions and by a same angle, and the motion control module is configured to control one or two of the first driving wheel and the second driving wheel to rotate.

In some embodiments, each of the first driving structure and the second driving structure includes a power base, a power motor, a steering base and a steering motor, the power motor is disposed on the power base, the steering motor is disposed on the steering base, and the power base is rotatably connected with the steering base, the steering motor is drivingly coupled to the power base to drive the power base to rotate, the steering base is connected to the vehicle body by means of a suspension portion, the power motor of the first driving structure drives the first driving wheel to rotate, and the power motor of the second driving structure drives the second driving wheel to rotate.

In some embodiments, the suspension portion includes a sliding rail, a guide rod and a suspension spring, and the guide rod is disposed on the vehicle body and extends in a height direction of the vehicle body; and a guide hole is disposed on the steering base, the guide rod is inserted into the guide hole, the suspension spring is inserted into the guide rod and the two ends of the suspension spring abut against the vehicle body and the steering base respectively; the sliding rail is disposed on the vehicle body and extends in the height direction of the vehicle body, a sliding groove is disposed on the steering base and the sliding rail is slidably connected to the sliding groove.

In some embodiments, each of the first driving structure and the second driving structure includes a power base, a power motor, a steering base and a steering motor, the power motor is disposed on the power base, the steering motor is disposed on the steering base, and the power base is rotatably connected with the steering base, the steering motor is drivingly coupled to the power base to drive the power base to rotate, the steering base is fixedly connected to the vehicle body, the power motor of the first driving structure drives the first driving wheel to rotate, and the power motor of the second driving structure drives the second driving wheel to rotate.

In some embodiments, the power base includes a circular top portion, and a gear ring is disposed on the outer edge of the circular top portion, the steering motor is drivingly coupled to a driving gear, and the driving gear is engaged with the gear ring; and a driven gear is further rotatably connected to the steering base.

In some embodiments, the first driving wheel is disposed on one side of a central axis of the vehicle body, and the second driving wheel is disposed on the other side of the central axis of the vehicle body; or the first driving wheel and the second driving wheel are disposed on a central axis of the vehicle body; or the first driving wheel and the second driving wheel are disposed on the same side of a central axis of the vehicle body.

In some embodiments, the vehicle body has a plurality of wheel mounting positions, at least one wheel mounting position of the plurality of wheel mounting positions is disposed on each of corner points of a rectangle, a center of gravity of the vehicle body is disposed inside the rectangle, the first driving wheel and the second driving wheel are disposed on two of the wheel mounting positions which are spaced apart along the length direction of the rectangle, and two universal wheels are disposed on the remaining two wheel mounting positions located at the other corner points of the rectangle; the rectangle is congruent with a horizontal projection of the vehicle body.

In some embodiments, the first driving wheel and the second driving wheel are disposed on the same side of the rectangle in the width direction; or the first driving wheel and the second driving wheel are disposed on opposite sides of the rectangle in the width direction; or each of the universal wheels is disposed on a corner of the rectangle, and the first driving wheel and the second driving wheel are disposed on a middle area of the rectangle and located between at least two of the universal wheels.

In some embodiments, in the normal mode, the motion control module is configured to control one of the first driving wheel and the second driving wheel to turn and the other of the first driving wheel and the second driving wheel not to turn; or, in the normal mode, the motion control module controls the first driving wheel to steer, and the second driving wheel follows the first driving wheel to steer, and a steering angle of the second driving wheel is less than a steering angle of the first driving wheel; or in the normal mode, the motion control module is configured to control the second driving wheel to steer, the first driving wheel follows the second driving wheel to steer, and a steering angle of the first driving wheel is less than a steering angle of the second driving wheel.

In some embodiments, the small steering radius mode includes a zero-position steering mode, and in the zero-position steering mode, steering angles of both the first driving wheel and the second driving wheel have reached a steering threshold value.

In some embodiments, the normal mode includes a first mode and a second mode; in the first mode, the motion control module is configured to control the first driving wheel to steer and control the second driving wheel to maintain its current steering position; in the second mode, the motion control module is configured to control the second driving wheel to steer and control the first driving wheel to maintain its current steering position.

In some embodiments, the multi-purpose elevating work platform further includes a controller, the controller is configured to perform man-machine interaction, the controller includes a mode switching module and the motion control module, the mode switching module is configured to input a switching instruction, and the motion control module is configured to switch the motion mode in response to the switching instruction received from the mode switching module; or the mode switching module is performed automatically based on vehicle configuration and status.

In some embodiments, the motion control module includes two operating devices, and each of the two operating devices receives a plurality of signal inputs to control a motion of the first driving wheel and the second driving wheel; one operating device is configured to control, through a signal input, the rotational speed output by the first driving wheel; or one operating device is configured to control, through a signal input, the rotational speed output by the second driving wheel; or one operating device is configured to control, through at least one signal input, the rotational speed output by the first driving wheel and the second driving wheel; the other operating device is configured to control, through a signal input, the steering angle output by the first driving wheel; or the other operating device is configured to control, through a signal input, the steering angle output by the second driving wheel; or the other operating device is configured to control, through at least one signal input, the steering angle output by the first driving wheel and the second driving wheel.

In some embodiments, a detection device is disposed on each of the operating devices for detecting whether an operator holds the operating device, the detection device is in communication connection with the motion control module; upon the detection device confirming that the operator holds the operating device; the motion control module controls the multi-purpose elevating work platform to move.

In some embodiments, the multi-purpose elevating work platform further includes a mast and a platform which is vertically movably connected to the mast for carrying a user; the first driving structure is disposed on a position close to a front end of the vehicle body, and the second driving structure is disposed on a position close to a rear end of the vehicle body; a first plate body and a second plate body which are vertically disposed, and the first plate body and the second plate body divide the vehicle body into a front portion, a middle portion and a rear portion in the length direction; the front portion is configured to position the first driving structure and the first driving wheel, the middle portion is configured to position the mast, and the rear portion is configured to position the second driving structure and the second driving wheel; the motion control module is disposed on the platform.

In some embodiments, the multi-purpose elevating work platform further includes a plurality of protective devices, at least one protective device is disposed on one side of the platform, and at least another protective device is disposed on the opposite side of the platform; each of the protective devices is rotatably connected to the platform; the multi-purpose elevating work platform further includes an position sensor and a detection circuit which is in communication with the motion control module , the position sensor is disposed on the platform, the detection circuit is disposed on the position sensor; when each of the protective devices is in an operating position, the protective device triggers the position sensor, and the detection circuit transmits a signal to the motion control module.

In some embodiments, the multi-purpose elevating work platform further includes a storage rack which is capable of ascending and descending relative to the platform, the storage rack is disposed on a front portion of the platform, the storage rack includes a fixed plate and a movable plate, the movable plate is configured to extend out or retract relative to the fixed plate so as to adjust the length of the storage rack, and the movable plate can be folded to a rear of the vehicle head of the vehicle body; the multi-purpose elevating work platform further includes an actuator, the actuator is disposed on the platform, and a telescopic end of the actuator is fixedly connected with the storage rack.

Compared with the prior art, the present invention has beneficial effects as follows:

The multi-purpose elevating work platform (MPEP) realizes a plurality of operation modes by the rotation and steering of the dual independent driving wheels, and supports three movement modes of normal motion, multi-directional motion and small-radius steering, which covers most scenarios of moving in a narrow aisles and confined areas, so that the MPEP can move more flexibly to reduce the burden of the operator.

### BRIEF DESCRIPTION OF THE DRAWINGS

The drawings, which constitute a part of the present invention, are used to provide a further understanding of the present invention, and schematic embodiments of the present invention and descriptions thereof are used to explain the present invention, and do not constitute an improper limitation on the present invention. In the drawings:

FIG. 1 illustrates a schematic diagram of a three-dimensional structure of a first angle of a multi-purpose elevating work platform of the present invention;

FIG. 2 illustrates a schematic diagram of a chassis layout of the multi-purpose elevating work platform of the present invention;

FIG. 3 illustrates a schematic diagram of another chassis layout of the present invention;

FIG. 4 illustrates a schematic structural diagram of a first driving structure of the present invention;

FIG. 5 illustrates a schematic diagram of a three-dimensional structure of a second angle of the multi-purpose elevating work platform of the present invention;

FIG. 6 illustrates a schematic diagram of steering of a first driving wheel and a second driving wheel in a normal mode of the present invention;

FIG. 7 illustrates a schematic diagram of steering of the first driving wheel and the second driving wheel in a multi-directional movement mode of the present invention;

FIG. 8 illustrates a schematic diagram of steering of the first driving wheel and the second driving wheel in a small steering radius mode of the present invention;

FIG. 9 illustrates a flowchart of control logic of the present invention;

FIG. 10 illustrates a schematic diagram of a handle of the present invention;

FIG. 11 illustrates a three-dimensional schematic structural diagram of a storage plate of the multi-purpose elevating work platform of the present invention;

FIG. 12 illustrates a schematic diagram of a platform of the multi-purpose elevating work platform of the present invention;

FIG. 13 illustrates a schematic diagram of a mast of the multi-purpose elevating work platform of the present invention;

FIG. 14 illustrates a schematic structural diagram of a third angle of the multi-purpose elevating work platform of the present invention;

FIG. 15 illustrates an upward view of Embodiment 1 of a multi-purpose elevating work platform of the present invention;

FIG. 16 illustrates an upward view of Embodiment 2 of a multi-purpose elevating work platform of the present invention;

FIG. 17 illustrates a schematic diagram of a vehicle body of the multi-purpose elevating work platform of the present invention;

FIG. 18 illustrates a schematic structural diagram of a fourth angle of the multi-purpose elevating work platform of the present invention;

FIG. 19 illustrates a schematic diagram of a three-dimensional structure of another embodiment of the multi-purpose elevating work platform of the present invention.

The above drawings include the following reference signs:

wheel mounting position 5, first driving structure 6, second driving structure 7, vehicle body 100, universal wheel 101, lamp mounting base 102, driving caution light 103, first plate body 104, second plate body 105, power supply battery 106, first driving wheel 200, second driving wheel 300, power base 410, power motor 420, steering motor 430, speed reducer 431, steering base 440, sliding rail 451, guide rod 452, suspension spring 453, gear ring 432, driving gear 433, driven gear 434, protective device 500, detection device 501, normal mode switch 601, multi-directional movement mode switch 602, small steering radius mode switch 603, mast 700, mast body 710, lifting structure 720, dragging chain 730, platform 800, actuator 810, fixed plate 811, movable plate 812, upper guard arm 820, lower guard arm 821, position sensor 822.

### DETAILED DESCRIPTION OF THE EMBODIMENTS

The present invention is further described below in combination with the drawings and embodiments.

It should be pointed out that the following detailed descriptions are all exemplary and are intended to provide further explanation of the present invention. Unless otherwise specified, all technical and scientific terms used herein have the same meanings as commonly understood by those ordinary skilled in the art to which the present invention belongs.

It should be noted that, terms used herein are for the purpose of describing specific embodiments only, and are not intended to limit the exemplary embodiments according to the present invention. As used herein, unless the context clearly dictates otherwise, a singular form is intended to include a plural form as well. In addition, it should also be understood that, when the terms "contain" and/or "include" are used in the present specification, they indicate the presence of features, steps, operations, devices, components and/or combinations thereof.

In the present invention, orientation or position relationships indicated by terms such as “upper”, “lower”, “left”, “right”, “front”, “rear”, “vertical”, “horizontal”, “side”, “bottom” and the like are orientation or position relationships shown on the basis of the drawings, and are relational words determined for the convenience of describing the structural relationships of various components or elements in the present invention, and do not refer to any component or element in the present invention, and thus cannot be understood as limitations to the present invention.

In the present invention, the terms “fixedly connected”, “connected” and “connection” should be understood in a broad sense, which indicates that the connection can be a fixed connection and can also be an integral connection or a detachable connection; and can be a direct connection and can also be an indirect connection through an intermediate medium. For those related scientific research or technical personnel in the art, the specific meanings of the above terms in the present invention can be understood according to specific situations, but cannot be understood as limitations to the present invention.

In the present invention, multi-purpose elevating work platform is MPEP.

### Embodiment 1

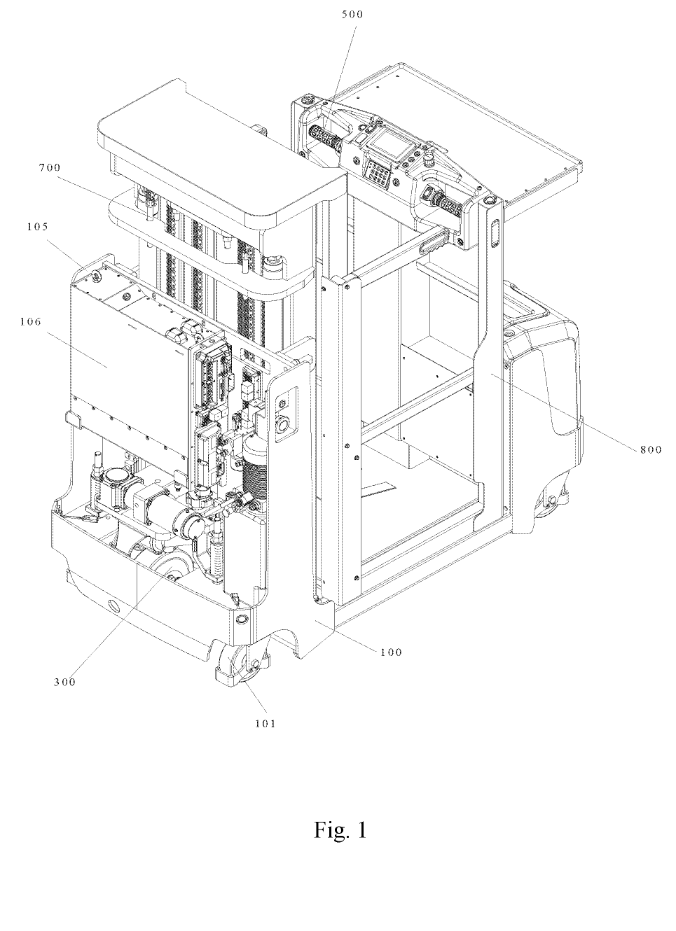

As shown in FIGS. 1-3, a MPEP includes a vehicle body 100, a first driving wheel 200, a second driving wheel 300 and a plurality of universal wheels 101. The first driving wheel 200, the second driving wheel 300 and the universal wheels 101 are located at the bottom of the vehicle body 100. The first driving wheel 200, the second driving wheel 300 and the universal wheels 101 are all wheel bodies. At least one of the first driving wheel 200 and the second driving wheel 300 rotate under the action of a torque, a wheel surface of the first driving wheel 200 and the second driving wheel 300 generates power to the vehicle body 100 by means of a friction force, so as to push the vehicle body 100 to move. The universal wheels 101 support the vehicle body 100. The universal wheels 101 are rotatably connected to a universal frame, and the universal frame is rotatably connected to the vehicle body 100. When the vehicle body 100 moves, the universal wheels 101 steer to minimum resistance positions according to the minimum potential energy law. When the vehicle body 100 performs various motion forms and are in various motion postures, the universal wheels 101 can support the vehicle body 100 to maintain the stability of the vehicle body 100.

In some embodiments, the universal wheels 101, the first driving wheel 200 and the second driving wheel 300 are all tangent to the same plane, and the plane is the ground.

In some embodiments, the first driving wheel 200 and the second driving wheel 300 have the same wheel diameter.

In some embodiments, the first driving wheel 200 and the second driving wheel 300 have the different wheel diameter.

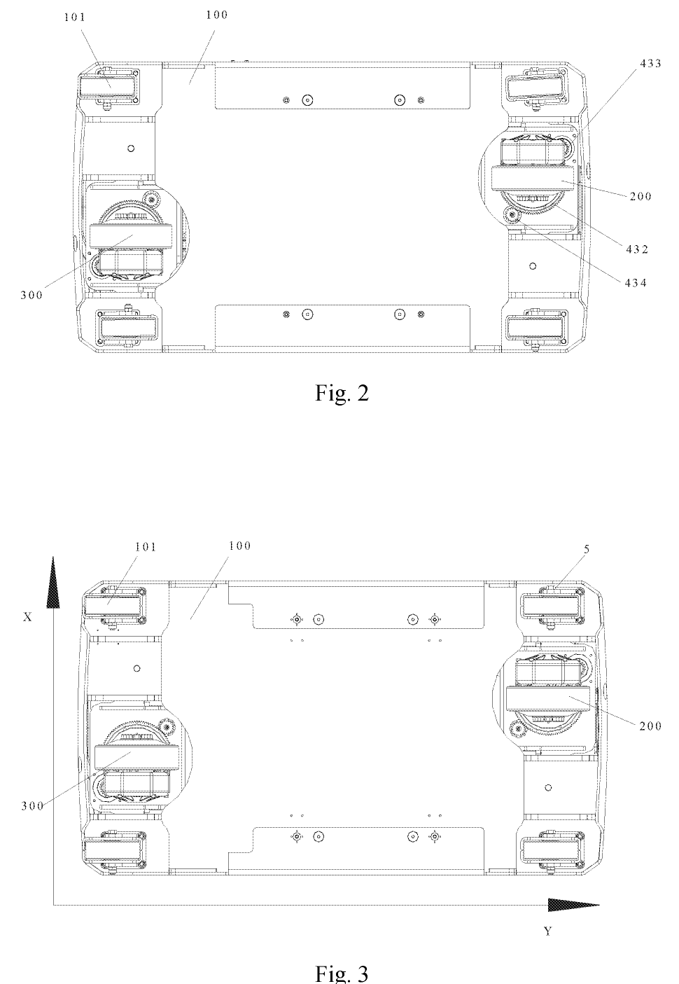

As shown in FIG. 2 and FIG. 3, the projection of the vehicle body 100 on the horizontal plane is rectangular, and the universal wheels 101 are located at corner point positions on the bottom of the vehicle body 100. In some embodiments, the length of the vehicle body 100 is relatively large, so that the universal wheels 101 are disposed at a plurality of positions of the vehicle body 100 in the length direction and the two ends of the vehicle body 100 in the width direction, so as to reduce a bending moment applied to the vehicle body 100.

In some embodiments, the first driving wheel 200 is located at a corner point position of the vehicle body 100, the second driving wheel 300 is located at a diagonal position of the first driving wheel 200, and the universal wheels 101 of the vehicle body 100 in this shape and structure are located on the remaining two corner points. Or, the first driving wheel 200 is located on one end of a long side of the vehicle body 100, and the second driving wheel 300 is located on the other end of the long side of the vehicle body 100.

The first driving wheel 200 and the second driving wheel 300 can independently move, and the motion includes rotation and steering, wherein the first driving wheel 200 can rotate and steer, and the second driving wheel 300 can rotate and steer. The rotation is that the first driving wheel 200 or the second driving wheel 300 performs circumferential rotation in the axial direction thereof; and the steering is that the first driving wheel 200 or the second driving wheel 300 deflects in the axial direction thereof. One end of the vehicle body is provided with a first driving structure, the other end of the vehicle body is provided with a second driving structure, the first driving structure drives the first driving wheel 200 to move, and the second driving structure drives the second driving wheel 300 to move.

The first driving wheel 200 and the second driving wheel 300 are located in the length direction of the vehicle body 100. One end of the vehicle body 100 is defined as a head end, and the other end away from the head end is a tail end. The first driving wheel 200 is located on the head end, and the second driving wheel 300 is located on the tail end.

In some embodiments, the first driving wheel 200 and the second driving wheel 300 are disposed on a central axis of the vehicle body 100.

In some other embodiments, the first driving wheel 200 is located on one side of the central axis of the vehicle body 100, and the second driving wheel 300 is located on the other side of the central axis of the vehicle body 100. Specifically, the first driving wheel 200 is located on the right side of the central axis of the vehicle body 100, and the second driving wheel 300 is located on the left side of the central axis of the vehicle body 100. In some possible solutions, the first driving wheel 200 is located on the left side of the central axis of the vehicle body 100, and the second driving wheel 300 is located on the right side of the central axis of the vehicle body 100, but it is not limited thereto. In some other embodiments, the first driving wheel 200 and the second driving wheel 300 are disposed on the same side of a central axis of the vehicle body 100.

It should be noted that, the central axis here can be either the X axis or the Y axis.

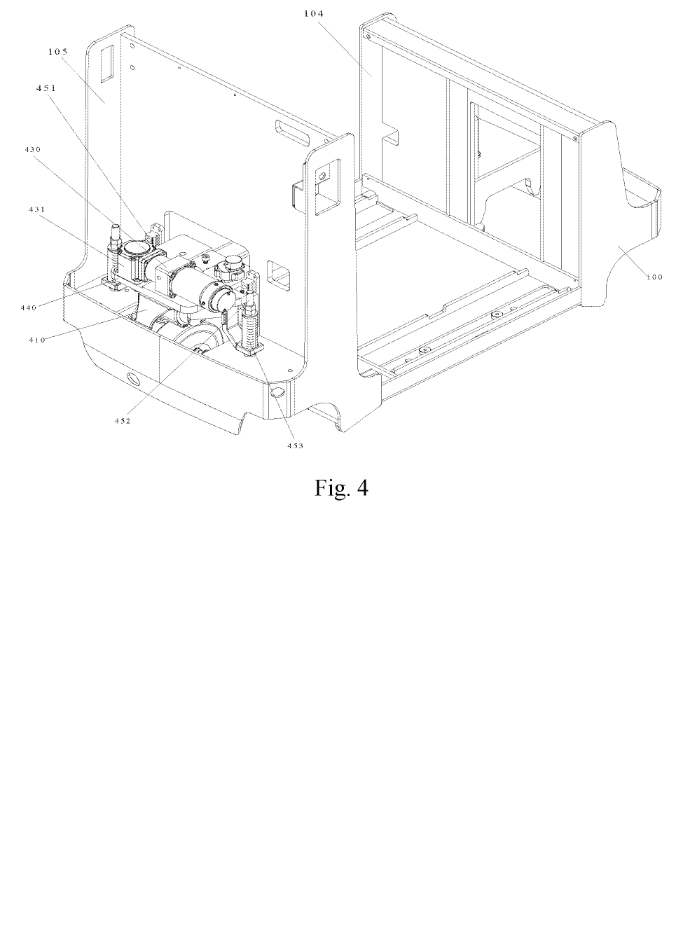

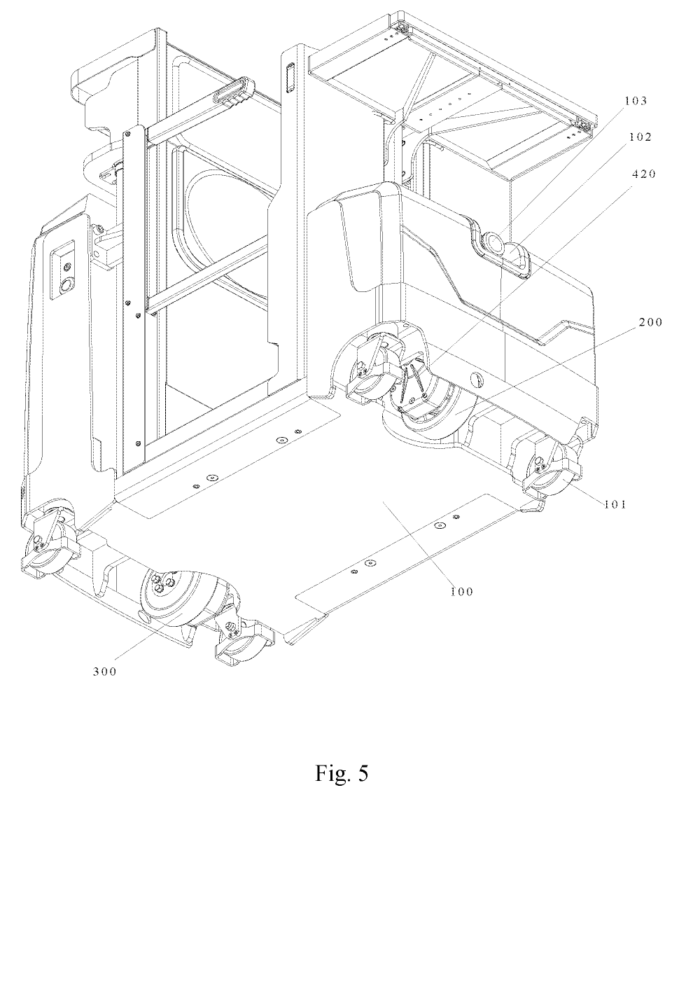

As shown in FIG. 4 and FIG. 5, the first driving structure includes a power base 410, a power motor 420 disposed on the power base 410, a steering base 440, and a steering motor 430 disposed on the steering base 440, the power base 410 is rotatably connected with the steering base 440, the steering motor 430 is in transmission connection with the power base 410 and drives the power base 410 to rotate, the steering base 440 is connected with the vehicle body 100 by a suspension portion, and the power motor 420 drives the first driving wheel 200 to rotate.

In the present embodiment, the structure of the second driving structure is the same as that of the first driving structure, the second driving structure includes a power base 410, a power motor 420 disposed on the power base 410, a steering base 440, and a steering motor 430 disposed on the steering base 440, the power base 410 is rotatably connected with the steering base 440, the steering motor 430 is in transmission connection with the power base 410 and drives the power base 410 to rotate, the steering base 440 is connected with the vehicle body 100 by a suspension portion, and the power motor 420 drives the second driving wheel 300 to rotate.

As shown in FIG. 4 and FIG. 5, the first driving structure and the second driving structure are respectively disposed on the front and rear ends of the vehicle body 100, the first driving structure and the second driving structure have the same specific components and similar weights, which can improve the weight distribution of the vehicle body 100 and improve the controllability of the vehicle body 100.

In the present embodiment, the suspension portion elastically provides the first driving structure and the second driving structure on the vehicle body 100, and performs vibration filtering by the elasticity thereof, thereby improving the riding experience.

It should be noted that, when the driving wheels are connected to the vehicle body in a floating manner, the supporting wheels are rigidly connected to the vehicle body; and when the driving wheels are connected to the vehicle body in a rigid manner, the supporting wheels are elastically connected to the vehicle body, and at this time, the supporting wheels can be arranged in a floating manner.

In some embodiments, the suspension portion includes a sliding rail 451, a guide rod 452 and a suspension spring 453, the guide rod 452 is disposed on the vehicle body 100 and is disposed in the height direction, the steering base 440 is provided with a guide hole, the guide rod 452 is inserted into the guide hole, the suspension spring 453 is inserted into the guide rod 452 and the two ends thereof abut against the vehicle body 100 and the steering base 440 respectively, the sliding rail 451 is disposed on the vehicle body 100 and is disposed in the height direction, the steering base 440 is provided with a sliding groove, and the sliding groove is slidably connected with the sliding rail 451.

As shown in FIG. 2 and FIG. 3, the steering motor 430 drives the power base 410 to rotate in the following manner: the power base 410 includes a top portion, a gear ring 432 is disposed on the outer edge of the top portion, the top of the power base 410 is circular and is provided with a gear ring 432 on the outer edge, the steering motor 430 is in transmission connection with a driving gear 433, and the driving gear 433 is engaged with the gear ring 432. The steering motor 430 is further in transmission connection with a speed reducer 431, the speed reducer 431 has a self-locking function, the self-locking function can be implemented by a worm gear structure, but it is not limited thereto, and according to the instructions of the present invention, those skilled in the art can select other suitable implementation manners in accordance with actual use requirements.

In some embodiments, teeth constituting the gear ring 432 are disposed outwards, the gear ring 432 is an outer gear ring 432, the driving gear 433 is engaged with the gear ring 432, and the driving gear 433 rotates to drive the gear ring 432 to rotate. The gear ring 432 drives the power base 410 and the first driving wheel 200 to rotate to realize a steering function.

A driven gear 434 is further rotatably connected to the steering base 440, the driven gear 434 and the driving gear 433 are disposed on two sides of the gear ring 432, and the circle center of the driven gear 434 and the circle center of the driving gear 433 are disposed on a straight line passing through the circle center of the gear ring 432.

Similarly, the gear ring 432 is an inner gear ring, the teeth constituting the gear ring 432 are disposed inwards, and the driving gear 433 and the driven gear 434 are disposed inside the inner gear ring 432 and are engaged with the inner gear ring 432. Since the gear ring 432 is disposed on the steering base 440, the top of the steering base 440 is provided with an upwardly disposed protruding ring, and the gear ring 432 is disposed in the protruding ring. However, the specific driving structure is not limited thereto.

Optionally, the MPEP is one of low-speed storage and transportation vehicles, and those skilled in the art can set the type of the low-speed storage and transportation vehicle according to actual positioning requirements, for example, the low-speed storage and transportation vehicle can be a forklift.

In the present embodiment, the MPEP further includes a controller, the controller is used for performing man-machine interaction, the controller includes a mode switching module and the motion control module, the mode switching module is provided with four switching instructions, and the motion control module switches the motion mode according to the switching instruction input by the mode switching module; or the mode switching module is performed automatically based on vehicle configuration and status.

In the present embodiment, the motion control module is disposed in the MPEP, and according to the posture and the motion state of the vehicle body 100 that are obtained by a motion sensor mounted on the vehicle body 100, the rotation speeds and the steering angles of the first driving wheel and the second driving wheel are corrected to ensure the stability of the motion of the vehicle body 100.

The motion mode of the MPEP includes normal modes, a multi-directional movement mode, and a small steering radius mode.

The switching instructions of the mode switching module respectively correspond to the above motion modes, and the mode switching module has identification information corresponding to the motion modes.

Optionally, the mode switching module includes independent buttons respectively corresponding to the motion modes. In some other embodiments, the mode switching module includes a knob having selectable gears, which are a normal mode switch 601, a multi-directional movement mode switch 602 and a small steering radius mode switch 603, which can also be other forms, and the present invention is not limited thereto; including automatic mode switch based on vehicle configuration. To enable an operator to more easily identify the current mode, prompt lights are disposed at corresponding mode switches in some embodiments.

It should be noted that, the number of the mode switches can be adjusted according to an actual situation.

In the present embodiment, the motion mode includes a normal mode, and the normal mode is similar to a conventional passenger car driving mode:

in the normal mode, the motion control module controls one of the first driving wheel 200 and the second driving wheel 300 to steer, and the motion control module controls one or two of the first driving wheel 200 and the second driving wheel 300 to rotate.

In some embodiments, the motion control module controls the first driving wheel 200 located at the head to steer, and the motion control module controls the second driving wheel 300 located at the tail to rotate, and the motion form thereof is similar to that of a rear-wheel drive vehicle, but it is not limited thereto; a control mode similar to that of a front-wheel drive vehicle can also be used, in which the motion control module controls the first driving wheel 200 located at the head to steer, and the motion control module controls the first driving wheel 200 located at the head to rotate; or a control mode similar to that of a four-wheel drive vehicle is used, in which the motion control module controls the first driving wheel 200 located at the head to steer, and the motion control module controls the first driving wheel 200 located at the head and the second driving wheel 300 located at the tail to rotate.

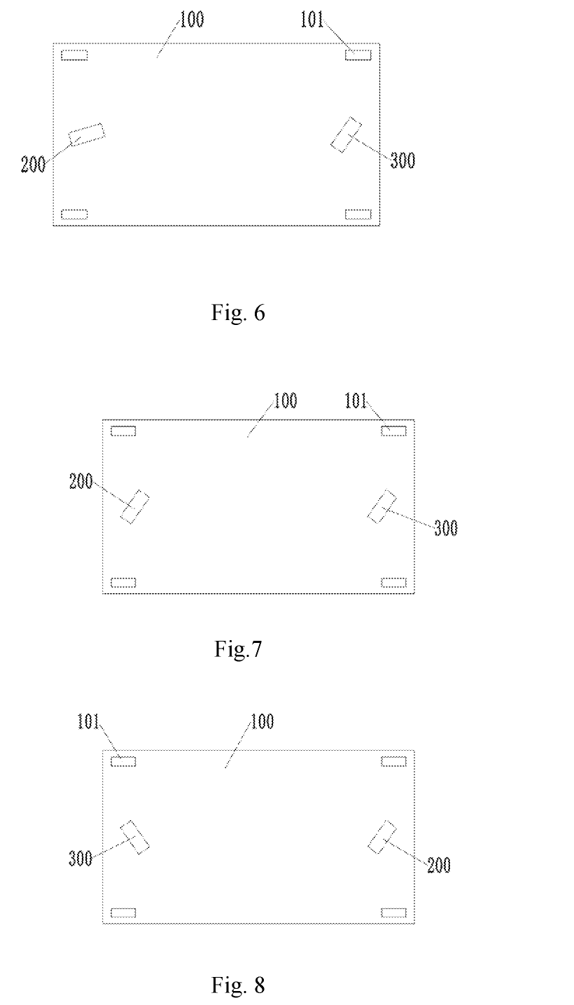

In some possible embodiments, the motion control module controls the second driving wheel 300 located at the tail to steer, and the motion control module controls the first driving wheel 200 and/or the second driving wheel 300 to move, which is not limited in the present invention. As shown in FIG. 6, in the normal mode, the motion control module controls the first driving wheel 200 to steer, wherein during the steering of the MPEP, the motion control module controls the second driving wheel 300 to adaptively steer according to the steering angle of the first driving wheel 200, and the steering angle of the second driving wheel 300 is less than the steering angle of the first driving wheel 200. For the embodiment in which the motion control module controls the second driving wheel 300 to steer, the motion control module controls the first driving wheel 200 to adaptively steer according to the steering angle of the second driving wheel 300. Specifically, the steering angle of the first driving wheel 200 is less than the steering angle of the second driving wheel 300. In order to adapt to the above two cases, the mode switching module is respectively provided with buttons or gears for representing a first normal mode of the former case and a second normal mode of the latter case, and thus four buttons or gears are generated in total.

In some possible embodiments, in the normal mode, the motion control module controls one of the first driving wheel 200 and the second driving wheel 300 to steer and the other not to steer.

As shown in FIG. 7, in the multi-directional movement mode, the motion control module controls the first driving wheel 200 and the second driving wheel 300 to steer synchronously, the motion control module detects and adjusts the first driving wheel 200 and the second driving wheel 300 to have the same steering direction and the same angle, and the motion control module controls one or two of the first driving wheel 200 and the second driving wheel 300 to rotate.

In the present embodiment, the multi-directional movement mode is also referred to as a panning mode, which is used for controlling the vehicle body 100 to move in any direction parallel to the vehicle body 100. Since the foregoing steering can be steering in left and right directions, the steering range of the first driving wheel 200 and the steering range of the second driving wheel 300 reach 180 degrees, which supports lateral movement of the vehicle body 100. Since the steering angle of the first driving wheel 200 and the steering angle of the second driving wheel 300 can be linearly adjusted between -90 degrees and 90 degrees, the vehicle body 100 also supports 0-degree movement, that is, linear movement.

In some embodiments, the motion control module controls the first driving wheel 200 to drive the vehicle body 100, and the second driving wheel 300 is driven; in some other embodiments, the motion control module controls the second driving wheel 300 to drive the vehicle body 100, and the first driving wheel 200 is driven; and in still some other embodiments, the motion control module controls the first driving wheel 200 and the second driving wheel 300 to synchronously drive, and the speeds of the first driving wheel 200 and the second driving wheel 300 relative to the ground are consistent.

As shown in FIG. 8, in the small steering radius mode, the motion control module controls the first driving wheel 200 and the second driving wheel 300 to steer synchronously, the steering angles are opposite and the dimensions of the angles are the same, and the motion control module controls one or two of the first driving wheel 200 and the second driving wheel 300 to rotate. Compared with the normal mode, the small steering radius mode can reduce the steering radius, specifically the turn-round radius, of the vehicle body 100.

In some embodiments, in the small steering radius mode, the first driving wheel and the second driving wheel have opposite steering angles and different angular magnitudes.

In some embodiments, the small steering radius mode further includes a zero-position steering mode, and in the zero-position steering mode, the steering angles of the first driving wheel 200 and the steering angle of the second driving wheel 300 reach a steering threshold value.

In some embodiments, the zero-position steering mode is set directly in the mode switching module as a switching mode just like the normal mode, the multi-directional movement mode and the small steering radius mode. After entering this mode, according to a signal input by the motion control module, the first driving wheel 200 and the second driving wheel 300 steer synchronously in opposite steering directions to a travel limit, wherein the steering angle is 90 degrees. The vehicle body 100 responds to the signal input by the motion control module and starts to rotate.

In some embodiments, the normal mode includes a first mode and a second mode; in the first mode, the motion control module controls the first driving wheel to steer, the second driving wheel steers synchronously with the first driving wheel, and the steering angle of the second driving wheel is less than the steering angle of the first driving wheel or no steering occurs; and in the second mode, the motion control module controls the second driving wheel to steer, the first driving wheel steers synchronously with the second driving wheel, and the steering angle of the first driving wheel is less than the steering angle of the second driving wheel or no steering occurs.

In some embodiments, the normal mode comprises a first mode and a second mode; in the first mode, the motion control module controls the steering of a first driving wheel, and the second driving wheel rotates following the first driving wheel, but the second driving wheel does not turn; and in a second mode, the motion control module controls the second driving wheel to turn, the first driving wheel rotates following the second driving wheel, but the first driving wheel does not turn.

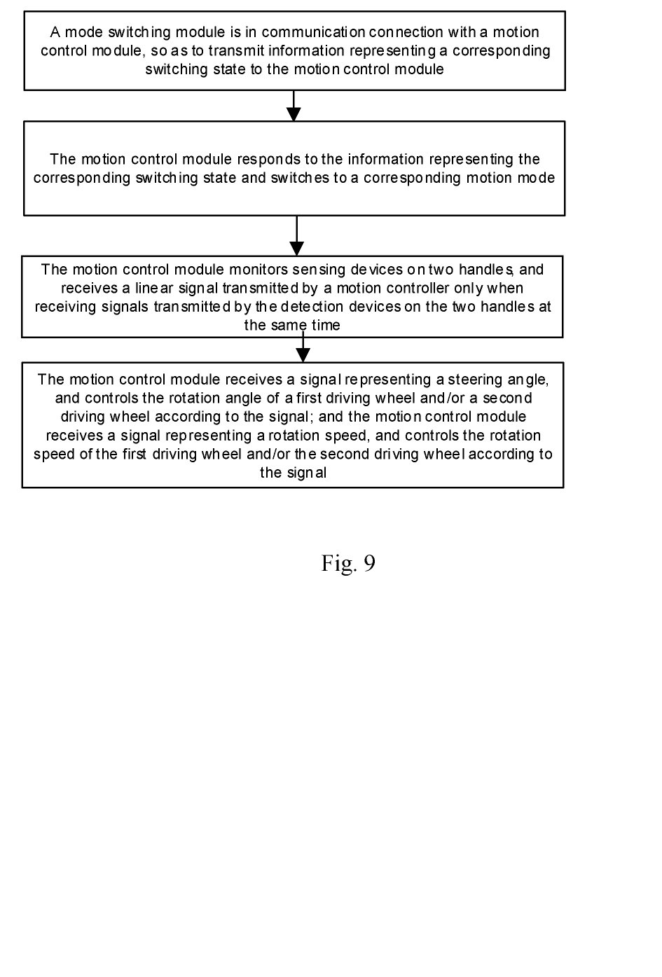

As shown in FIG. 9, the control logic of the MPEP is as follows:

the mode switching module is in communication connection with the motion control module, so as to transmit information representing the corresponding switching instruction to the motion control module;

the motion control module responds to the information representing the corresponding switching instruction and switches to the corresponding motion mode;

the motion control module monitors detection devices 501 on two protective devices 500, and receives a signal transmitted by the motion control module only when receiving signals transmitted by the detection devices 501 on the two protective devices 500 at the same time;

the motion control module receives a signal representing the steering angle, and controls the rotation angle of the first driving wheel 200 according to the signal; or controls the rotation angle of the second driving wheel 300 according to the signal; or controls the rotation angles of the first driving wheel 200 and the first driving wheel 200 according to the signal;

the motion control module receives a signal representing the rotation speed, and controls the rotation speed of the first driving wheel 200 according to the signal; or controls the rotation speed of the second driving wheel 300 according to the signal; or controls the rotation speeds of first driving wheel 200 and the second driving wheel 300 according to the signal; and

when the mode switching module on the MPEP switches the state, the motion control module makes a response and switches to the responded motion mode. In some embodiments, after the motion mode is switched, the first driving wheel 200 and the second driving wheel 300 are reset to a zero position, and at the zero-position state, the rotation speed of the first driving wheel 200 and the rotation speed of the second driving wheel 300 are 0, and the steering angles are 0 degrees.

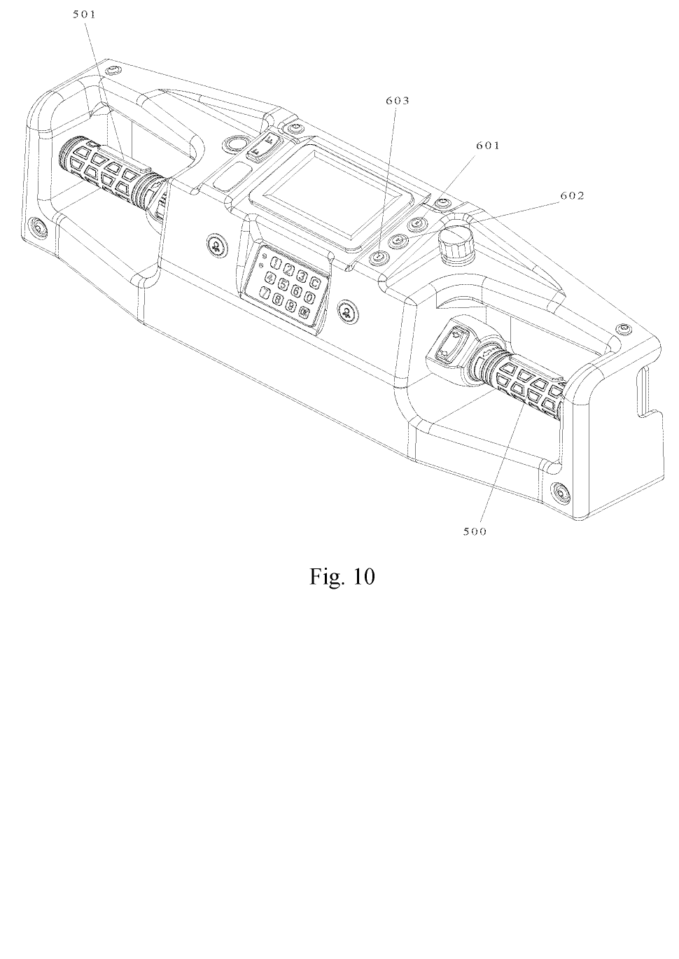

As shown in FIG. 10, the motion control module includes two operating devices 500, and each of the two operating devices 500 receives a plurality of signal inputs to control a motion of the first driving wheel and the second driving wheel; one operating device 500 is configured to control, through a signal input, the rotational speed output by the first driving wheel; or one operating device 500 is configured to control, through a signal input, the rotational speed output by the second driving wheel; or one operating device 500 is configured to control, through at least one signal input, the rotational speed output by the first driving wheel and the second driving wheel; the other operating device 500 is configured to control, through a signal input, the steering angle output by the first driving wheel; or the other operating device 500 is configured to control, through a signal input, the steering angle output by the second driving wheel; or the other operating device 500 is configured to control, through at least one signal input, the steering angle output by the first driving wheel and the second driving wheel.

Optionally, the operating device 500 is a handle or a steering wheel.

Optionally, each of the operating devices can be equipped steering angle control for simultaneous control of steering angle for the first driving wheel 200 and the second driving wheel 300.

In some embodiments, the operating device 500 is a handle, and each handle receives a plurality of signal inputs to control the motion of the first driving wheel 200 and the second driving wheel 300, the rotation speed output from the first driving wheel 200 is controlled by one signal input, or the rotation speed output from the second driving wheel 300 is controlled by one signal input, or the rotation speeds output from the first driving wheel 200 and the second driving wheel 300 are controlled by two signal inputs. The steering angle output from the first driving wheel 200 is controlled by another signal input; or the steering angle output from the second driving wheel 300 is controlled by another signal input; or the steering angles output from the first driving wheel 200 and the second driving wheel 300 are controlled by another two signal inputs.

Optionally, the axial directions of the two handles are disposed on the same plane, the two handles respectively correspond to two hands of a person, and the spacing between the two handles is slightly greater than the width of the shoulders of an adult. the structure is also applicable to a human body structure, thereby alleviating the fatigue feeling caused by long-term contact with the two handles 500.

Optionally, the signal inputs include one or more of push-pull forces received by the two handles 500, and the turning degrees of the two handles for rotating around the axial direction thereof.

In the present embodiment, the handles include an inner handle, and an outer handle rotatably connected and sleeved on the inner handle. The outer handle and the inner handle are elastically connected, a zero position is generated in an elastic connection manner, and the outer handle is always at the zero position in the absence of an external force. A rotational angle of each of the outer handle and the inner handle is detectable by an encoder or others. The inner handle is relatively fixed to the vehicle body, and the outer handle rotates in the axial direction relative to the inner handle. By detecting the rotational angle of the outer handle relative to the inner handle, the foregoing signal generated by the handle rotating in the axial direction to the opening degree is generated, the opening degree generated by the rotation angle is in positive correlation with the steering angle, that is, the greater the opening degree is.

In some embodiments, the foregoing operation of resetting to the zero position is automatically performed after the two hands of the operator deviate from the handles or is performed since the signal inputs of the handles are zero.

Optionally, the surface of the handle is provided with pressure sensors, the pressure sensors are arranged on a side wall of the handle in the form of a dot matrix, a corresponding input signal can be generated by means of push-pull, the direction of a force applied to the handle is judged according to the input signal, and then according to the magnitude of the thrust, the motion control module controls the first driving wheel 200 and/or the second driving wheel 300 to steer and rotate, the magnitude of the thrust is in positive correlation with the rotation speed, that is, the greater the thrust is, the greater the rotation speed is.

Optionally, the surface of the handle is monitored by photoelectric sensors or any other type of sensor capable of detecting whether the operator’s hand is resting on the handle.

In the present embodiment, the signal input is mapped to better conform to human perception, thereby avoiding errors and reducing training costs.

Optionally, an inner side of the handle corresponding to a thumb area of the person is further provided with a control button or a rotatable structure, and the control button or the rotatable structure can control, by the own controller of the vehicle body, other components attached to the vehicle body, and with the MPEP of the present invention as an example, the controller can control the manned platform to ascend or descend. However, it is not limited thereto; ascending and descending control can also be performed on the fork of a forklift.

Optionally, one handle controls the rotation speed output from the first driving wheel 200 by the motion control module via the signal input; or one handle controls the rotation speed output from the second driving wheel 300 by the motion control module via the signal input; or one handle controls the rotation speed output from the first driving wheel 200 and the second driving wheel 300 by the motion control module via two signal inputs. The other handle controls the steering angle output from the first driving wheel 200 by the motion control module via the signal input; or the other handle controls the steering angle output from the second driving wheel 300 by the motion control module via the signal input; or the other handle controls the steering angle output from the first driving wheel 200 and the second driving wheel 300 by the motion control module via two signal inputs.

In some embodiments, the motion control module receives signals generated by the two handles rotating to the opening degrees, so as to control the steering angle output from the first driving wheel 200; or so as to control the steering angle output from the second driving wheel 300; or so as to control the steering angles output from the first driving wheel 200 and the second driving wheel 300. Receives signals provided by the pressure sensors on the surfaces of the handles 500, so as to control the rotation speed output from the first driving wheel 200; or so as to control the rotation speed output from the second driving wheel 300; or so as to control the rotation speeds output from the first driving wheel 200 and the second driving wheel 300.

In the above three motion modes, the functions corresponding to the two handles are always the same. For example, the handle on the right side is always used for controlling the rotation output from the first driving wheel 200; or the handle on the right side is always used for controlling the rotation output from the second driving wheel 300; or the handle on the right side is always used for controlling the rotation output from the first driving wheel 200 and the second driving wheel 300, that is, the feeding of the vehicle body. The handle on the left side is always used for controlling the steering of the first driving wheel 200; or the handle on the left side is always used for controlling the steering of the second driving wheel 300; or the handle on the left side is always used for controlling the steering of the first driving wheel 200 and the second driving wheel 300, that is, the steering of the vehicle body. The above settings can reduce the mental load of the user and thus reduce the error probability.

In the present embodiment, the handles are further provided with detection devices 501 for detecting whether the operator holds the two handles, the detection devices 501 are in communication connection with the motion control module, and when the detection devices 501 confirm that the operator holds the two handles, the motion control module controls the MPEP to move.

Optionally, the detection device 501 is a capacitive device, a pressure detection device, or a photoelectric sensing device.

In some embodiments, the detection device 501 is the pressure sensor mentioned above, and the pressure sensor is used detecting whether the two hands of the operator are on the handle, the control process of the MPEP is substantially as follows:

the operator activates the MPEP:

the operator enters the platform of the MPEP;

selects a corresponding switching instruction by the mode switching module;

places the two hands on the two handles;

inputs a manipulation command by controlling the two handles; and

powers off the vehicle after completing the work.

As shown in FIG. 1 and FIG. 4, the vehicle body 100 is provided with a vertically disposed first plate body 104 at a position close to the front end, the vehicle body 100 is provided with a vertically disposed second plate body 105 at a position close to the rear end, and the first plate body 104 and the second plate body 105 divide the vehicle body 100 into a front portion, a middle portion and a rear portion in the length direction. The second plate body 105 is higher than the first plate body 104, a mounting space is provided at a position close to the upper portion of the second plate body 105, and the mounting space is used for mounting a power supply battery 106.

In the present embodiment, the front portion is used for positioning the first driving structure and the first driving wheel 200, the middle portion is used for positioning a mast 700, and the rear portion is used for positioning the second driving structure and the second driving wheel 300. The layout mode is better, the driving wheels can be disposed on the front and rear sides of the platform, the height of the vehicle body is reduced, and the center of gravity of the vehicle is reduced, so that the operator enters the platform more easily.

As shown in FIG. 5, the front end of the vehicle body 100 is recessed inwards to form a lamp mounting base 102, and a driving caution light 103 is mounted in the lamp mounting base 102. The front and rear ends of the vehicle body 100 are provided with a corresponding front caution light and a rear caution light, and both the length of the front caution light and the length of the rear caution light do not exceed the length of the vehicle body 100.

As shown in FIG. 1 and FIG. 5, the mast 700 is detachably connected to the vehicle body, a mast section 710 is detachably connected between the first plate body 104 and the second plate body 105, a lifting structure 720 is slidably connected to the mast 710, a driving oil cylinder is disposed on the top of the mast 710, the driving oil cylinder is in driving connection with a reel, a dragging chain 730 is wound on the reel, and the dragging chain 730 is connected with the lifting structure 720. A platform 800 is detachably connected to the lifting structure 720. In some embodiments, the lifting structure 720 and the platform 800 are of an integrated structure; and in some other embodiments, the lifting structure 720 is detachably connected with the platform 800. The platform 800 is used to carry a user.

Optionally, the driving oil cylinder can be replaced by alternative linear actuator.

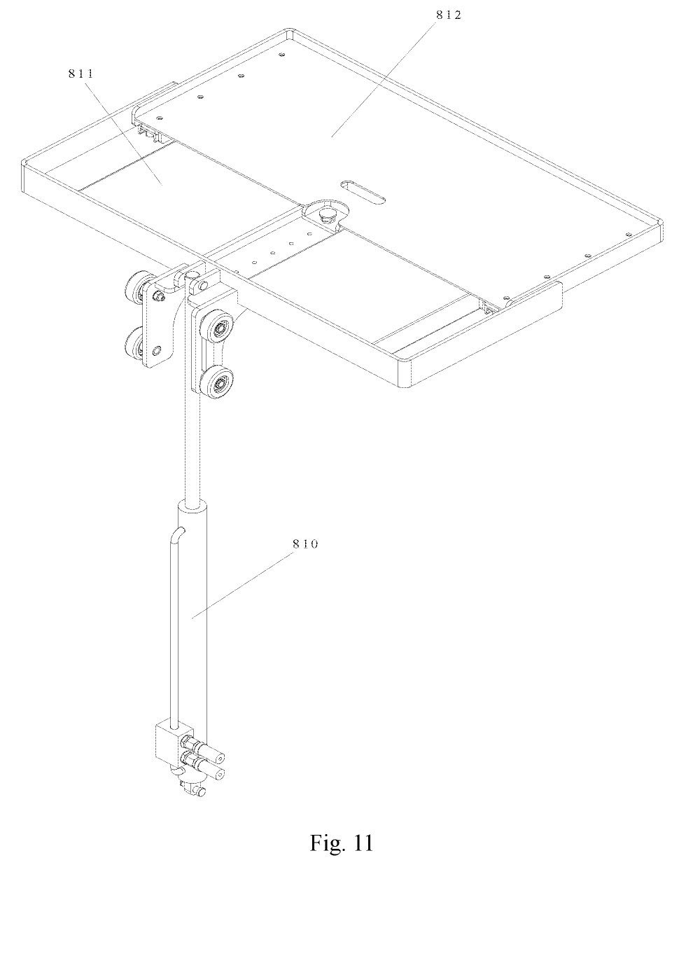

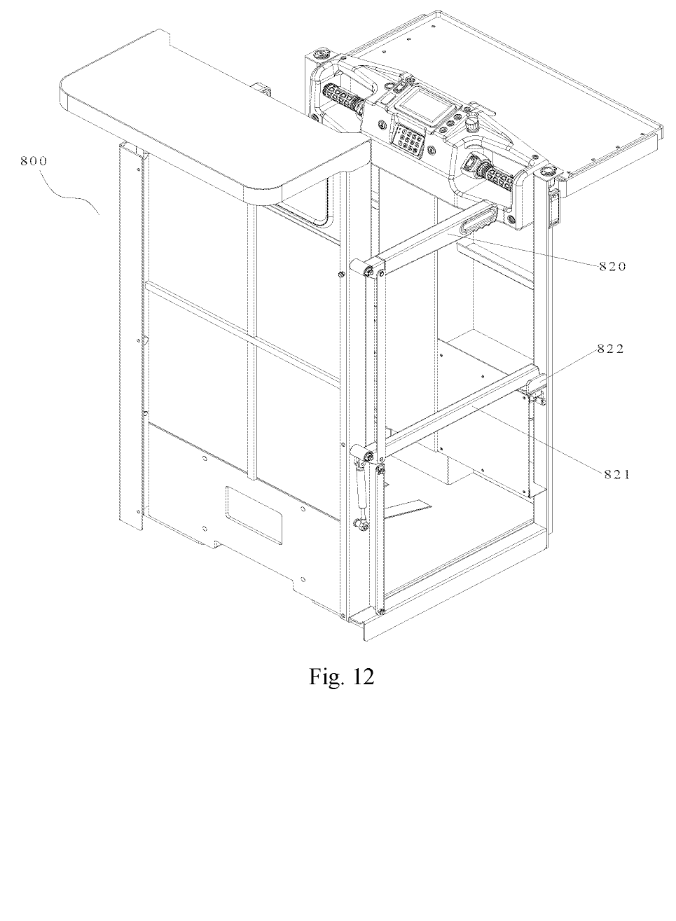

As shown in FIG. 11, the front portion of the platform 800 is provided with a storage rack capable of ascending and descending relative to the platform 800, the platform 800 is provided with an actuator 810, a telescopic end of the actuator 810 is fixedly connected with the storage rack, the storage rack includes a fixed plate 811 and a movable plate 812, the movable plate 812 can extend out or retract relative to the fixed plate 811 so as to adjust the length of the storage rack, and the movable plate 812 can be folded to the rear of the vehicle head of the vehicle body 100.

In some embodiments, the front part of the platform can be provided with a storage plate capable of moving up and down relative to the platform, an actuator is provided on the platform, and a telescopic end of the actuator is fixedly connected to the object placing plate.

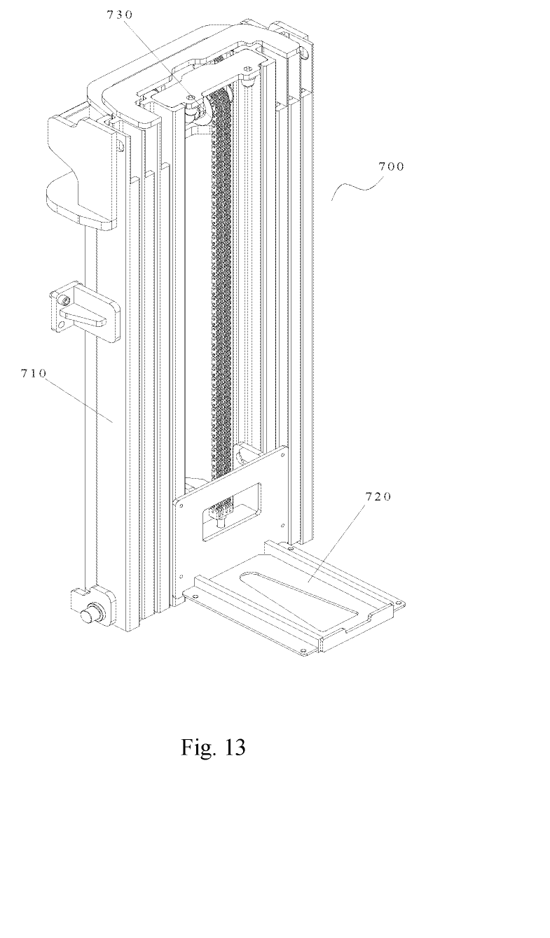

As shown in FIG. 13, the mast 700 includes the mast body 710 and the lifting structure 720 capable of ascending and descending relative to the mast body 710, the platform 800 is mounted on the lifting structure 720, and the mast body 710 is mounted between the first plate body 104 and the second plate body 105.

It should be noted that the connection between the platform 800 and the mast frame 700 is not limited thereto, and can be adjusted according to the working conditions and usage requirements.

In some embodiments, the platform is mounted on the mast body without any lifting movement.

As shown in FIG. 12, the MPEP further comprises a plurality of protective devices, at least one protective device is disposed on one side of the platform, and at least another protective device is disposed on the opposite side of the platform; each of the protective devices is rotatably connected to the platform; the MPEP further comprises an position sensor and a detection circuit which is in communication with the motion control module , the position sensor is disposed on the platform, the detection circuit is disposed on the position sensor; when each of the protective devices is in an operating position, the protective device triggers the position sensor, and the detection circuit transmits a signal to the motion control module.

In some embodiments, protective device is a guard arm, the guard arm include an upper guard arm 820 and a lower guard arm 821, the upper guard arm 820 and the lower guard arm 821 are connected by a connecting rod to rotate synchronously, the platform 800 is provided with an position sensor 822, the position sensor 822 is provided with a detection circuit in communication with the motion control module, and when the guard arms are in a operating position, the lower guard arm 821 is attached to the position sensor 822, and the detection circuit transmits a signal to the motion control module.

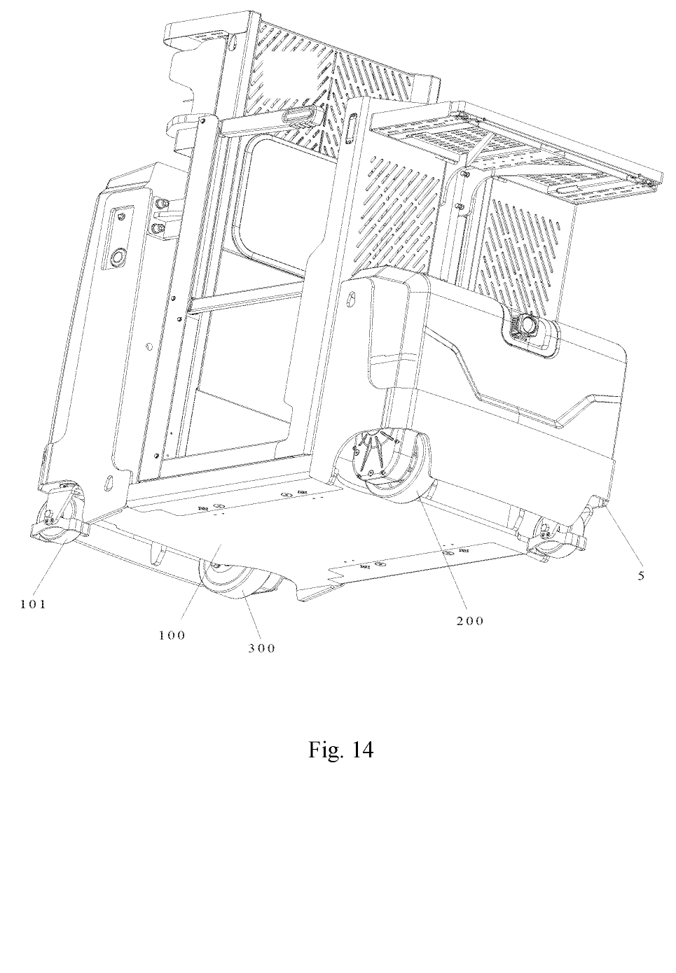

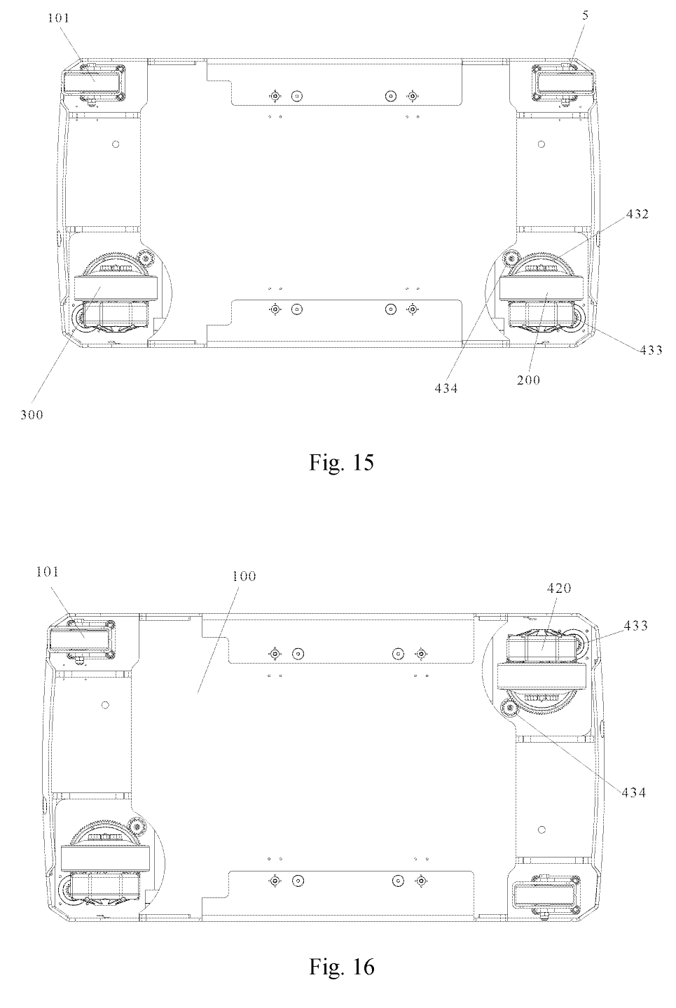

As shown in FIGS. 14-18, the vehicle body 100 has a plurality of wheel mounting positions 5, and the wheel mounting positions 5 are located on corner points of a rectangle. Specifically, the vehicle body 100 has four wheel mounting positions 5 in total. The center of gravity of the vehicle body 100 is located inside the rectangle, thereby avoiding an overturning accident due to the overturning of the vehicle body 100.

The rectangle coincides with the shape of a projection of the vehicle body 100 on the horizontal plane. In some possible embodiments, the rectangle is greater than the projection shape of the vehicle body 100 on the horizontal plane or less than the projection shape of the vehicle body 100 on the horizontal plane, the rectangle and a pattern generated by the projection shape of the vehicle body 100 on the horizontal plane have the same shape but different dimensions.

In the present embodiment, the first driving wheel 200 and the second driving wheel 300 are disposed on two wheel mounting positions 5 of the rectangle in the length direction, and two universal wheels 101 are mounted on the wheel mounting positions 5 corresponding to the other two corner points of the rectangle. In some embodiments, the first driving wheel 200 and the second driving wheel 300 are located on the same side of the rectangle in the width direction. In some other embodiments, the first driving wheel 200 and the second driving wheel 300 are located on different sides of the rectangle in the width direction. Specifically, the first driving wheel 200 is located on a left front wheel, and the second driving wheel 300 is located on a left rear wheel; or the first driving wheel 200 is located on a right front wheel, and the second driving wheel 300 is located on a right rear wheel; or the first driving wheel 200 is located on the left front wheel, and the second driving wheel 300 is located on the right rear wheel; or the first driving wheel 200 is located on the right front wheel, and the second driving wheel 300 is located on the left rear wheel; or each of the universal wheels is disposed on a corner of the rectangle, and the first driving wheel 200 and the second driving wheel 300 are disposed on a middle area of the rectangle and located between at least two of the universal wheels.

Corresponding to the positions of the first driving wheel 200 and the second driving wheel 300, the vehicle body 100 is provided with a first driving structure 6 and a second driving structure 7, the first driving structure 6 drives the first driving wheel 200 to move, the second driving structure 7 drives the second driving wheel 300 to move, and the motion includes rotation and steering.

### Embodiment 2

The difference between the MPEP and the MPEP in Embodiment 1 is that the structures of the driving structures are different.

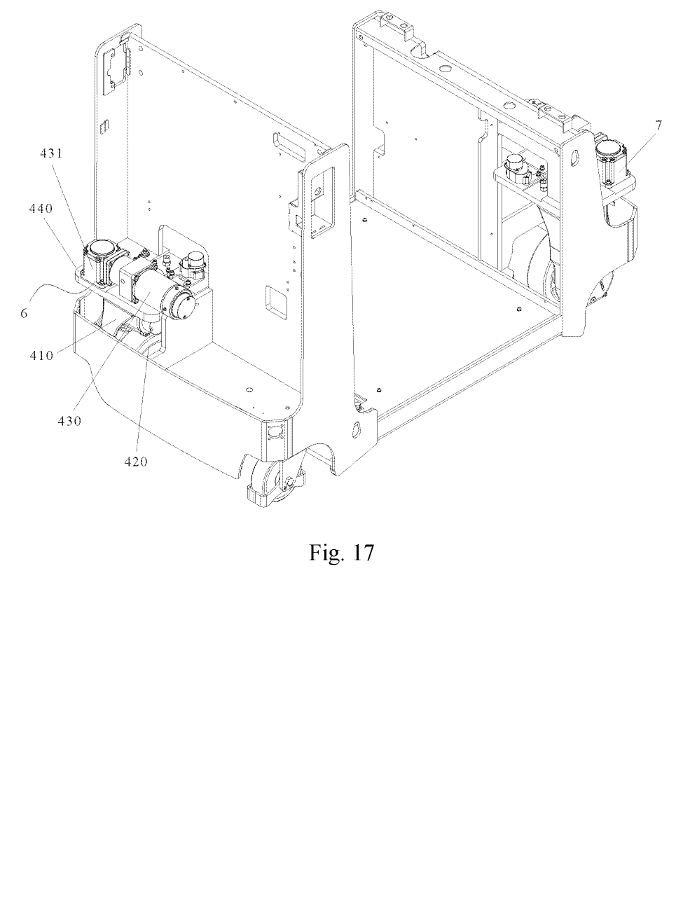

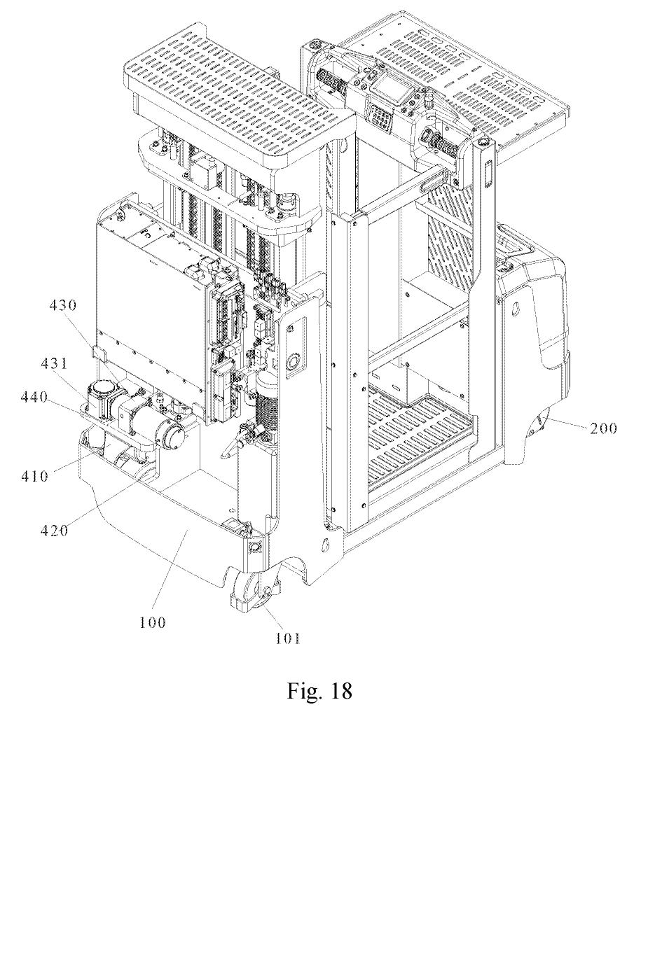

As shown in FIG. 17 and FIG. 18, the first driving structure 6 includes a power base 410, a power motor 420 disposed on the power base 410, a steering base 440, and a steering motor 430 disposed on the steering base 440, the power base 410 is rotatably connected with the steering base 440, the steering motor 430 is in transmission connection with the power base 410 and drives the power base 410 to rotate, the steering base 440 is fixedly connected to the vehicle body 100, and the power motor 420 drives the first driving wheel 200 to rotate. The structure of the second driving structure 7 is the same as that of the first driving structure 6, a driving motor of the second driving structure 7 drives the second driving wheel 300 to rotate. the driving motor and the power base 410 of the first driving structure 6 are in transmission connection by the speed reducer 431; and the driving motor and the power base 410 of the second driving structure 7 are in transmission connection by the speed reducer 431.

In the present embodiment, the top of the power base 410 is circular and is provided with a gear ring 432 on the outer edge, the steering motor 430 is in transmission connection with a driving gear 433, and the driving gear 433 is engaged with the gear ring 432. A driven gear 434 is further rotatably connected to the steering base 440, the driven gear 434 and the driving gear 433 are disposed on two sides of the gear ring 432, the circle center of the driven gear 434 and the circle center of the driving gear 433 are disposed on a straight line passing through the circle center of the gear ring 432, and the structure can further improve the steering precision of the driving wheels and improve the stability of the driving structures.

The present invention provides a plurality of motion forms as an example, but it is not limited thereto. According to the instructions of the present invention, those skilled in the art can select other motion combinations of the first driving wheel 200 and the second driving wheel 300 in accordance with actual use requirements to generate new motion forms.

### Embodiment 3

The difference between the MPEP and the MPEP in Embodiment 1 is that the mounting positions of power supply batteries are different.

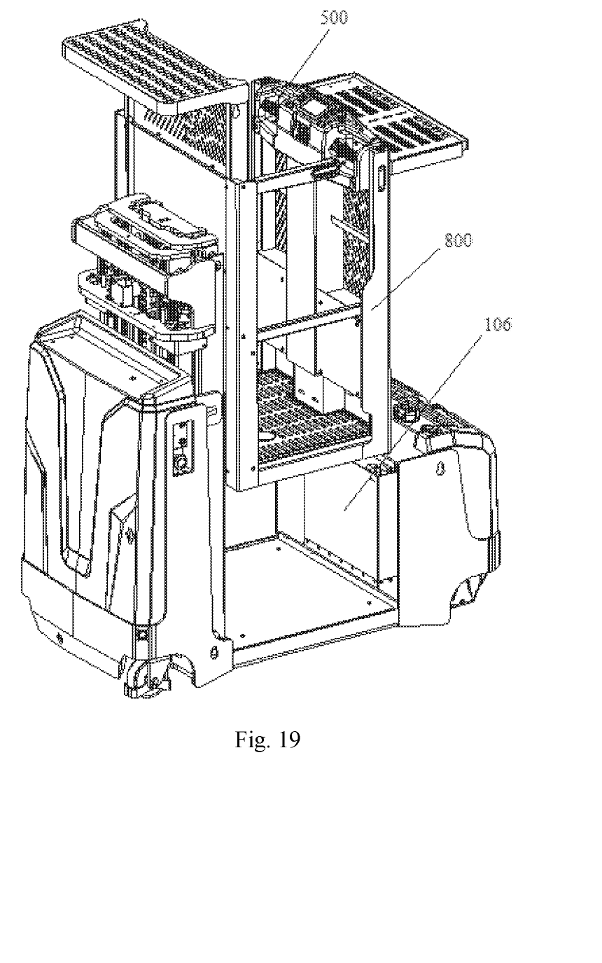

As shown in FIG. 19, a front central portion of the vehicle body is provided with a mounting space for mounting the power supply battery 106.

Obviously, the embodiments described above are only a part of the embodiments of the present invention, rather than all of the embodiments. All other embodiments, obtained by those ordinary skilled in the art based on the embodiments in the present invention without creative efforts, shall fall within the protection scope of the present invention.

It should be noted that, terms used herein are for the purpose of describing specific embodiments, and are not intended to limit the exemplary embodiments according to the present invention. As used herein, unless the context clearly dictates otherwise, a singular form is intended to include a plural form as well. In addition, it should also be understood that, when the terms “contain” and/or “include” are used in the present specification, they indicate the presence of features, steps, works, devices, components and/or combinations thereof.

It should be noted that, the terms “first” and “second” and the like in the specification, the claims and the above drawings of the present invention are used for distinguishing similar objects, and are not necessarily used for describing a specific sequence or precedence order. It should be understood that the data used in this way can be exchanged under appropriate circumstances, so that the embodiments of the present invention described herein can be implemented in a sequence other than those illustrated or described herein.

The foregoing descriptions are only preferred embodiments of the present invention, and are not intended to limit the present invention, and for those skilled in the art, the present invention can have various modifications and changes. Any modifications, equivalent replacements, improvements and the like, made within the spirit and principles of the present invention, shall all be included in the protection scope of the present invention.

What is claimed is:

1. A multi-purpose elevating work platform with dual driving wheels, wherein the multi-purpose elevating work platform comprises a vehicle body, a first driving wheel, a second driving wheel, a plurality of universal wheels and a motion control module; the plurality of universal wheels are disposed at positions close to an outer edge of the vehicle body, the first driving wheel and the second driving wheel are located in the length direction of the vehicle body; the multi-purpose elevating work platform further comprises a first driving structure and a second driving structure ,the first driving structure is disposed on one end of the vehicle body, the second driving structure is disposed on the other end of the vehicle body, the first driving structure drives the first driving wheel to rotate or steer, and the second driving structure drives the second driving wheel to rotate or steer; the multi-purpose elevating work platform has a plurality of motion modes, according to the plurality of motion modes, the motion control module is configured to control at least one of the first driving wheel and the second driving wheel to rotate and control at least one of the first driving wheel and the second driving wheel to steer.

2. The multi-purpose elevating work platform as claimed in claim 1, wherein the plurality of motion modes comprise a normal mode, a multi-directional movement mode and a small steering radius mode; in the normal mode, the motion control module is configured to control one or two of the first driving wheel and the second driving wheel to steer and control one or two of the first driving wheel and the second driving wheel to rotate; in the multi-directional movement mode, the motion control module is configured to control the first driving wheel and the second driving wheel to steer synchronously in a same steering direction and by a same angle, and the motion control module is configured to control one or two of the first driving wheel and the second driving wheel to rotate; and in the small steering radius mode, the motion control module is configured to control the first driving wheel and the second driving wheel to steer synchronously in opposite steering directions and by a same angle, and the motion control module is configured to control one or two of the first driving wheel and the second driving wheel to rotate.

3. The multi-purpose elevating work platform as claimed in claim 1, wherein each of the first driving structure and the second driving structure comprises a power base, a power motor, a steering base and a steering motor, the power motor is disposed on the power base, the steering motor is disposed on the steering base, and the power base is rotatably connected with the steering base, the steering motor is drivingly coupled to the power base to drive the power base to rotate, the steering base is connected to the vehicle body by means of a suspension portion, the power motor of the first driving structure drives the first driving wheel to rotate, and the power motor of the second driving structure drives the second driving wheel to rotate.

4. The multi-purpose elevating work platform as claimed in claim 3, wherein the suspension portion comprises a sliding rail, a guide rod and a suspension spring, and the guide rod is disposed on the vehicle body and extends in a height direction of the vehicle body; and a guide hole is disposed on the steering base, the guide rod is inserted into the guide hole, the suspension spring is inserted into the guide rod and the two ends of the suspension spring abut against the vehicle body and the steering base respectively; the sliding rail is disposed on the vehicle body and extends in the height direction of the vehicle body, a sliding groove is disposed on the steering base and the sliding rail is slidably connected to the sliding groove.

5. The multi-purpose elevating work platform as claimed in claim 1, wherein each of the first driving structure and the second driving structure comprises a power base, a power motor, a steering base and a steering motor, the power motor is disposed on the power base, the steering motor is disposed on the steering base, and the power base is rotatably connected with the steering base, the steering motor is drivingly coupled to the power base to drive the power base to rotate, the steering base is fixedly connected to the vehicle body, the power motor of the first driving structure drives the first driving wheel to rotate, and the power motor of the second driving structure drives the second driving wheel to rotate.

6. The multi-purpose elevating work platform as claimed in claim 3, wherein the power base comprises a circular top portion, and a gear ring is disposed on the outer edge of the circular top portion, the steering motor is drivingly coupled to a driving gear, and the driving gear is engaged with the gear ring; and a driven gear is further rotatably connected to the steering base.

7. The multi-purpose elevating work platform as claimed in claim 1, wherein the first driving wheel is disposed on one side of a central axis of the vehicle body, and the second driving wheel is disposed on the other side of the central axis of the vehicle body; or the first driving wheel and the second driving wheel are disposed on a central axis of the vehicle body; or the first driving wheel and the second driving wheel are disposed on the same side of a central axis of the vehicle body.

8. The multi-purpose elevating work platform as claimed in claim 1, wherein the vehicle body has a plurality of wheel mounting positions, at least one wheel mounting position of the plurality of wheel mounting positions is disposed on each of corner points of a rectangle, a center of gravity of the vehicle body is disposed inside the rectangle, the first driving wheel and the second driving wheel are disposed on two of the wheel mounting positions which are spaced apart along the length direction of the rectangle, and two universal wheels are disposed on the remaining two wheel mounting positions located at the other corner points of the rectangle; the rectangle is congruent with a horizontal projection of the vehicle body.

9. The multi-purpose elevating work platform as claimed in claim 8, wherein the first driving wheel and the second driving wheel are disposed on the same side of the rectangle in the width direction; or the first driving wheel and the second driving wheel are disposed on opposite sides of the rectangle in the width direction; or each of the universal wheels is disposed on a corner of the rectangle, and the first driving wheel and the second driving wheel are disposed on a middle area of the rectangle and located between at least two of the universal wheels.

10. The multi-purpose elevating work platform as claimed in claim 2, wherein in the normal mode, the motion control module is configured to control one of the first driving wheel and the second driving wheel to turn and the other of the first driving wheel and the second driving wheel not to turn; or, in the normal mode, the motion control module controls the first driving wheel to steer, and the second driving wheel follows the first driving wheel to steer, and a steering angle of the second driving wheel is less than a steering angle of the first driving wheel; or in the normal mode, the motion control module is configured to control the second driving wheel to steer, the first driving wheel follows the second driving wheel to steer, and a steering angle of the first driving wheel is less than a steering angle of the second driving wheel.

11. The multi-purpose elevating work platform as claimed in claim 2, wherein the small steering radius mode comprises a zero-position steering mode, and in the zero-position steering mode, steering angles of both the first driving wheel and the second driving wheel have reached a steering threshold value.

12. The multi-purpose elevating work platform as claimed in claim 2, wherein the normal mode comprises a first mode and a second mode; in the first mode, the motion control module is configured to control the first driving wheel to steer and control the second driving wheel to maintain its current steering position; in the second mode, the motion control module is configured to control the second driving wheel to steer and control the first driving wheel to maintain its current steering position.

13. The multi-purpose elevating work platform as claimed in claim 1, wherein the multi-purpose elevating work platform further comprises a controller, the controller is configured to perform man-machine interaction, the controller comprises a mode switching module and the motion control module, the mode switching module is configured to input a switching instruction, and the motion control module is configured to switch the motion mode in response to the switching instruction received from the mode switching module; or the mode switching module is performed automatically based on vehicle configuration and status.

14. The multi-purpose elevating work platform as claimed in claim 1, wherein the motion control module comprises two operating devices, and each of the two operating devices receives a plurality of signal inputs to control a motion of the first driving wheel and the second driving wheel; one operating device is configured to control, through a signal input, the rotational speed output by the first driving wheel; or one operating device is configured to control, through a signal input, the rotational speed output by the second driving wheel; or one operating device is configured to control, through at least one signal input, the rotational speed output by the first driving wheel and the second driving wheel; the other operating device is configured to control, through a signal input, the steering angle output by the first driving wheel; or the other operating device is configured to control, through a signal input, the steering angle output by the second driving wheel; or the other operating device is configured to control, through at least one signal input, the steering angle output by the first driving wheel and the second driving wheel.

15. The multi-purpose elevating work platform as claimed in claim 14, wherein a detection device is disposed on each of the operating devices for detecting whether an operator holds the operating device, the detection device is in communication connection with the motion control module; upon the detection device confirming that the operator holds the operating device, the motion control module controls the multi-purpose elevating work platform to move.

16. The multi-purpose elevating work platform as claimed in claim 1, wherein the multi-purpose elevating work platform further comprises a mast and a platform which is vertically movably connected to the mast for carrying a user; the first driving structure is disposed on a position close to a front end of the vehicle body, and the second driving structure is disposed on a position close to a rear end of the vehicle body; a first plate body and a second plate body which are vertically disposed, and the first plate body and the second plate body divide the vehicle body into a front portion, a middle portion and a rear portion in the length direction; the front portion is configured to position the first driving structure and the first driving wheel, the middle portion is configured to position the mast, and the rear portion is configured to position the second driving structure and the second driving wheel; the motion control module is disposed on the platform.

17. The multi-purpose elevating work platform as claimed in claim 16, wherein the multi-purpose elevating work platform further comprises a plurality of protective devices, at least one protective device is disposed on one side of the platform, and at least another protective device is disposed on the opposite side of the platform; each of the protective devices is rotatably connected to the platform; the multi-purpose elevating work platform further comprises an position sensor and a detection circuit which is in communication with the motion control module , the position sensor is disposed on the platform, the detection circuit is disposed on the position sensor; when each of the protective devices is in an operating position, the protective device triggers the position sensor, and the detection circuit transmits a signal to the motion control module.

18. The multi-purpose elevating work platform as claimed in claim 16, wherein the multi-purpose elevating work platform further comprises a storage rack which is capable of ascending and descending relative to the platform, the storage rack is disposed on a front portion of the platform, the storage rack comprises a fixed plate and a movable plate, the movable plate is configured to extend out or retract relative to the fixed plate so as to adjust the length of the storage rack, and the movable plate can be folded to a rear of the vehicle head of the vehicle body; the multi-purpose elevating work platform further comprises an actuator, the actuator is disposed on the platform, and a telescopic end of the actuator is fixedly connected with the storage rack.
